(19) United States
(12) Patent Application Publication
(10) Pub. No.: US 2016/0176065 A1
(43) Pub. Date: Jun. 23, 2016

(54) Feeding Machine

(71) Applicant: Chin-Chi Lin, Taichung City (TW)

(72) Inventor: Chin-Chi Lin, Taichung City (TW)

(21) Appl. No.: 14/572,933

(22) Filed: Dec. 17, 2014

(51) Int. Cl. B27C 1/12; B23Q 3/00

(52) U.S. Cl. CPC B27C 1/12; B23Q 3/002

(57) ABSTRACT

A feeding machine includes: a machine shell including a connecting portion that has a first connecting surface and a second connecting surface inclinedly connected to the first connecting surface; a feeding unit connected to the machine shell and including a plurality of feeding wheels; a driving unit connected to the machine shell and configured to drive the feeding wheels; a rotating shaft unit including a shaft seat and a rotating shaft that is connected to the shaft seat; a bracket unit including a bracket seat that is pivotally connected to the shaft seat of the rotating shaft unit. The shaft seat is threaded on a selected one of the first connecting surface and the second connecting surface.

### FIELD OF THE INVENTION

This invention relates to a feeding machine, and more particularly to a feeding machine having a feeding unit that can be disposed at a selected one of multiple positions.

### BACKGROUND OF THE INVENTION

A feeding machine is used to feed a workpiece, such as a wood, to allow a planning or cutting operation to be performed on the workpiece. According to different hanging types, such feeding machines can be divided into two types—a vertical hanging type and an inclined hanging type.

Referring to FIG. 1, a conventional inclined hanging type feeding machine 11 is shown to include a main body 111 and a bracket unit 112 inclinedly and rotatably connected to the main body 111. The main body 111 is rotatable relative to the bracket unit 112 so as to meet different requirements when feeding the workpiece.

Referring to FIG. 2, a conventional vertical hanging type feeding machine 12 is shown to include a main body 121 and a bracket unit 122 vertically and rotatably connected to the main body 121. The main body 121 is rotatable relative to the bracket unit 122 so that the workpiece can be fed along different directions.

The main body 111, 121 of each conventional feeding machine 11, 12 is only suitable for the corresponding bracket unit 112, 122. Therefore, to meet all requirements during manufacturing, multiple feeding machines are needed at the same time, thereby increasing the molding cost and the storage cost.

### SUMMARY OF THE INVENTION

Therefore, the object of the present invention is to provide a feeding machine that can overcome the aforesaid drawback of the prior art.

According to this invention, a feeding machine includes a machine shell, a feeding unit, a driving unit, a rotating shaft unit, and a bracket unit. The machine shell includes a connecting portion that has a first connecting surface and a second connecting surface inclinedly connected to the first connecting surface. The feeding unit is connected to the machine shell and includes a plurality of feeding wheels. The driving unit is connected to the machine shell and is configured to drive the feeding wheels. The rotating shaft unit includes a shaft seat and a rotating shaft that is connected to the shaft seat. The shaft seat is threaded on a selected one of the first connecting surface and the second connecting surface. The bracket unit includes a bracket seat that is pivotally connected to the shaft seat of the rotating shaft unit.

### BRIEF DESCRIPTION OF THE DRAWINGS

Other features and advantages of the present invention will become apparent in the following detailed description of the embodiment of this invention, with reference to the accompanying drawings, in which:

FIG. 1 is a fragmentary perspective view of a conventional inclined hanging type feeding machine;

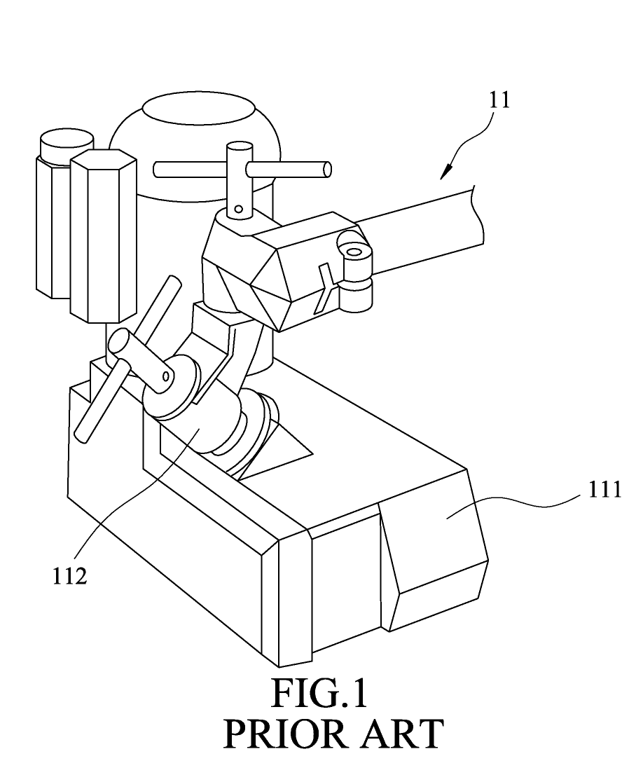

FIG. 2 is a fragmentary perspective view of a conventional vertical hanging type feeding machine;

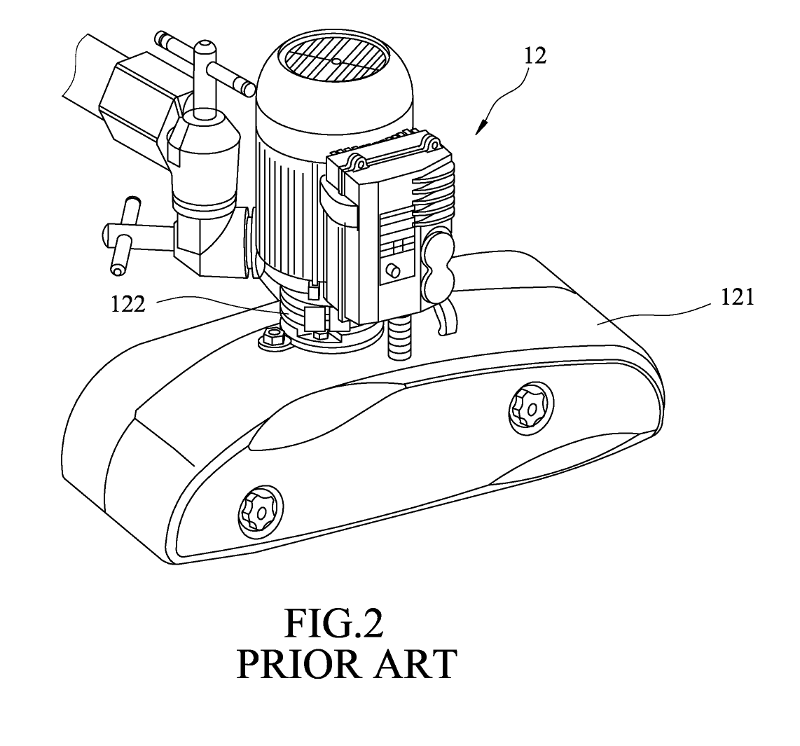

FIG. 3 is a partly exploded perspective view of the embodiment of a feeding machine according to this invention;

FIG. 4 is a partly sectional side view of the embodiment, illustrating that a shaft seat is threaded on a second connecting surface such that a central axis of a feeding wheel is horizontal;

FIG. 5 is a schematic view of the embodiment, illustrating that the shaft seat is threaded on the second connecting surface such that the central axis of the feeding wheel is vertical; and

FIG. 6 is an assembled perspective view of this embodiment, illustrating that the shaft seat is threaded on a first connecting surface.

### DETAILED DESCRIPTION OF THE EMBODIMENT

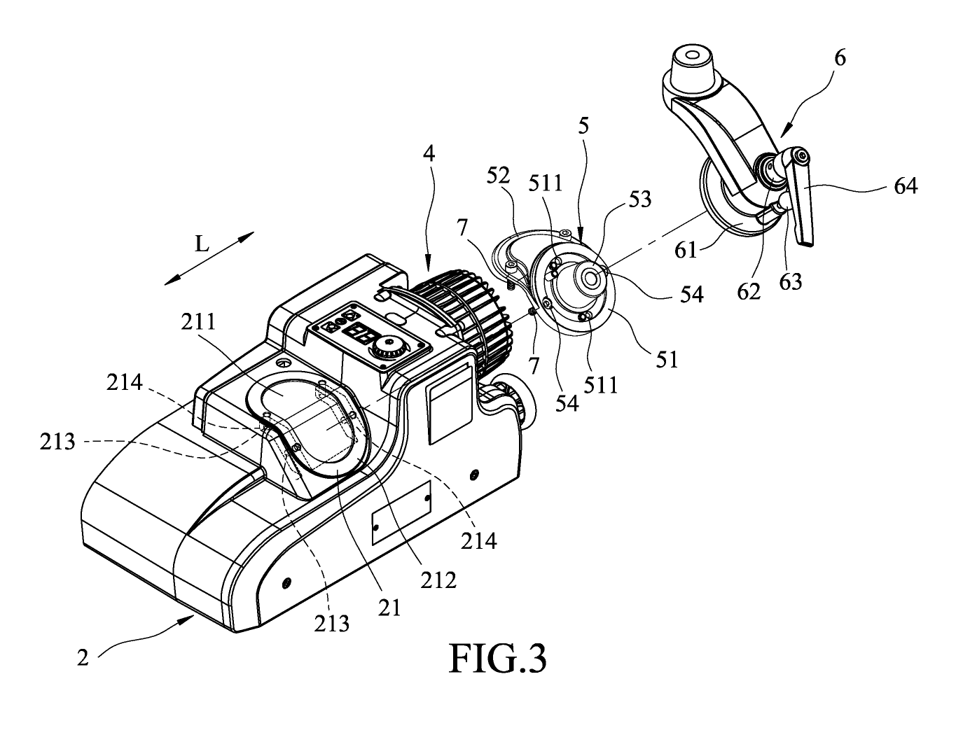

Referring to FIGS. 3 to 5, the embodiment of a feeding machine according to the present invention is adapted to feed a workpiece (e.g., wood 100) and is shown to include a machine shell 2, a feeding unit 3, a driving unit 4, a rotating shaft unit 5, a bracket unit 6 and a plurality of lock bolts 7.

The machine shell 2 includes a connecting portion 21 . The connecting portion 21 includes a first connecting surface 211, a second connecting surface 212 inclinedly connected to the first connecting surface 211, and a plurality of ribs 214. The connecting portion 21 is formed with a plurality of threaded holes 213. In this embodiment, each of the threaded holes 213 extends through a corresponding one of the ribs 214 so as to provide a strong structural configuration. In this embodiment, the first connecting surface 211 faces upwardly to serve as a top surface. The second connecting surface 212 is inclined with respect to the first connecting surface 211 at an angle (θ) of 135 degrees. However, it should be noted that the angle (θ) is not limited to 135 degrees and may vary based on actual requirements.

The feeding unit 3 is connected to the machine shell 2 and includes a plurality of feeding wheels 31.

The driving unit 4 is connected to the machine shell 2 and is configured to drive the feeding wheels 31. By virtue of a driving force provided by the driving unit 4 to drive the feeding wheels 31 of the feeding unit 3, the feeding machine according to this invention is capable of feeding the wood 100.

The rotating shaft unit 5 includes a shaft seat 51, a rotating shaft 53, an extending member 52 and a plurality of fixing holes 54. The shaft seat 51 is threaded on a selected one of the first connecting surface 211 and the second connecting surface 212. The extending member 52 is connected to the shaft seat 51 and is threaded on the other one of the first connecting surface 211 and the second connecting surface 212. In this embodiment, the shaft seat 51 is threaded on the second connecting surface 212, and the extending member 52 is threaded on the first connecting surface 211.

The rotating shaft 53 is connected to the shaft seat 51 and is frustoconical. In this embodiment, the shaft seat 51, the extending member 52 and the rotating shaft 53 are formed as one piece, and the rotating shaft 53 extends perpendicularly from the second connecting surface 212 of the machine shell 2. However, it should be understood that the shaft seat 51, the extending member 52 and the rotating shaft 53 may be manufactured separately and then be assembled together. Moreover, in a variation of this embodiment, the extending member 52 may also be omitted. The fixing holes 54 are formed in the shaft seat 51 and the extending member 52, and are aligned respectively with the threaded holes 213 of the connecting portion 21 of the machine shell 2. In this embodiment, the number of the fixing holes 54 of the rotating shaft unit 5 is four. Two of the fixing holes 54 are adjacent to the rotating shaft 53 and are formed in the shaft seat 51, and the other two of the fixing holes 54 are formed in the extending member 52. In this embodiment, each of the fixing holes 54 is located at a respective one of vertices of a substantial rectangle (see FIG. 3) so as to achieve a comparatively strong structural configuration. In this embodiment, the number of the threaded holes 213 of the connecting portion 21 is also four. Two of the threaded holes 213 are formed in the first connecting surface 211, and the other two of the threaded holes 213 are formed in the second connecting surface 212.

The lock bolts 7 extend respectively through the fixing holes 54 and engage respectively the threaded holes 213.

The bracket unit 6 includes a bracket seat 61, a connecting rod 62, a rotary lever 64 and a positioning pin 63. The bracket seat 61 is pivotally connected to the shaft seat 51 of the rotating shaft unit 5 by the connecting rod 62, and is formed with a frustoconical hole 611 so as to permit the bracket seat 61 to be sleeved rotatably on the rotating shaft 53. The connecting rod 62 is mounted rotatably on the bracket seat 61 and has one end threadedly connected to the bracket seat 61. The rotary lever 64 extends laterally from the other end of the connecting rod 62. The rotary lever 64 and the rotating shaft 53 are respectively disposed at two opposite sides of the bracket seat 61. The shaft seat 51 of the rotating shaft unit 5 is further formed with two positioning holes 511. The positioning pin 63 is adjacent to the connecting rod 62, extends through the bracket seat 61, and extends into a selected one of the positioning holes 511 of the shaft seat 51 of the rotating shaft unit 5.

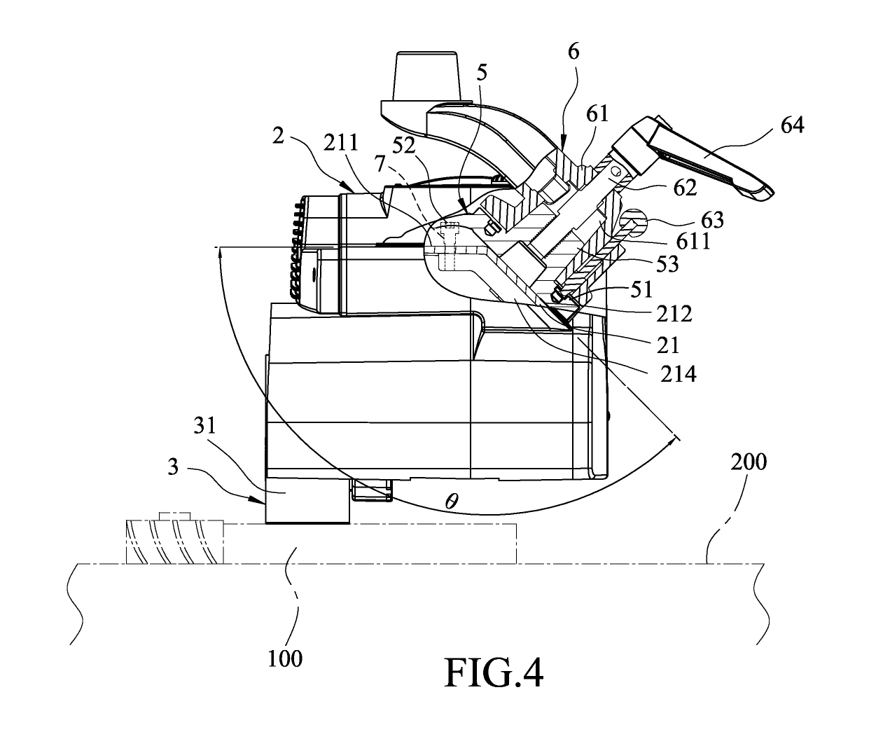

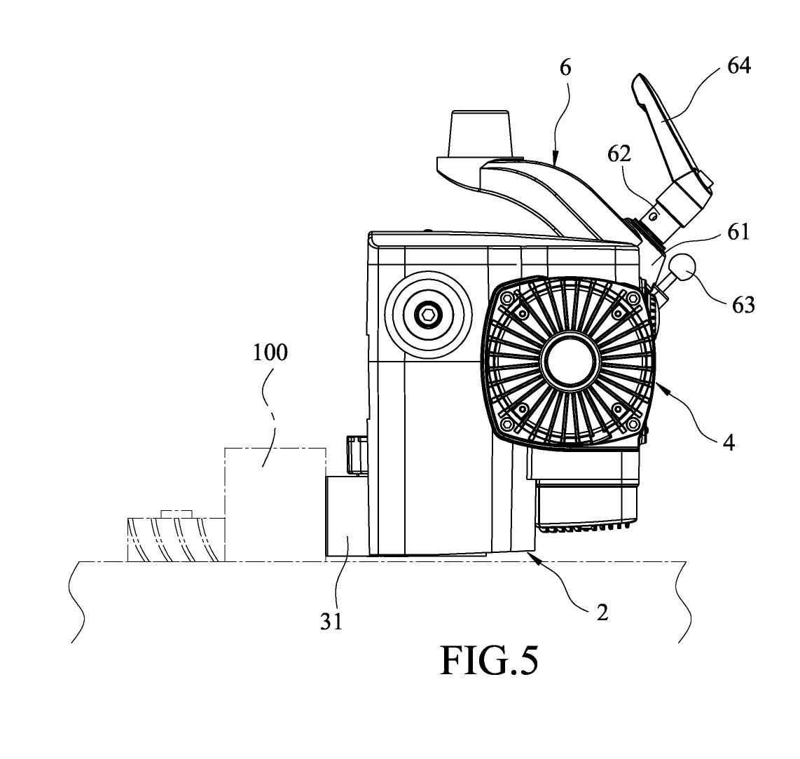

It is worth noting that, in this embodiment, the rotating shaft 53 is inclined with respect to a horizontal plane 200 (see FIG. 4) at an angle of 45 degrees. The machine shell 2 is rotatable relative to the bracket seat 61 such that a central axis of each of the feeding wheels 31 can be disposed between a horizontal position (as shown in FIG. 4) and a vertical position (as shown in FIG. 5). After the machine shell 2 is disposed at a desired position (e.g., a vertical position or a horizontal position), the positioning pin 63 is extended through the bracket seat 61 and into a corresponding positioning hole 511 of the shaft seat 51 to prevent relative rotation between the machine shell 2 and the bracket unit 6.

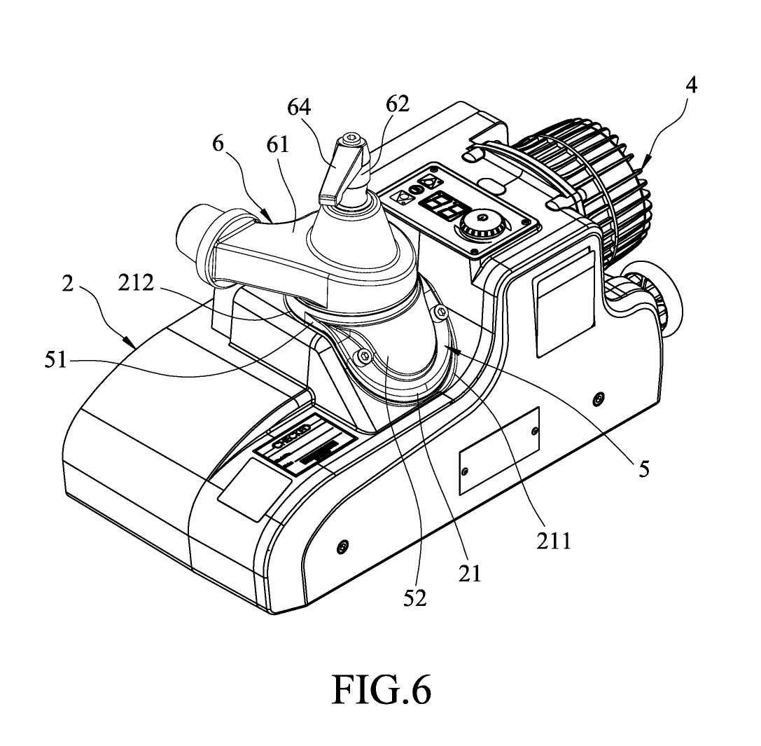

Referring to FIG. 6, the shaft seat 51 is threaded on the first connecting surface 211, and the extending member 52 is threaded on the second connecting surface 212. The machine shell 2 is rotatable relative to the bracket seat 61 such that the wood 100 can be fed by the feeding wheels 31 of the feeding unit 3 in different directions.

To conclude, the feeding machine of this disclosure is advantageous for the following reasons:

(1) When the shaft seat 51 is threaded on the second connecting surface 212, the axes of the feeding wheels 31 of the feeding unit 3 can be adjusted between the vertical position (see FIG. 5) and the horizontal position (see FIG. 4) so as to meet different requirements when feeding the wood 100.

(2) Moreover, when the shaft seat 51 is threaded on the first connecting surface 211 (see FIG. 6), the wood 100 can be fed by the feeding wheels 31 of the feeding unit 3 in different directions for feeding the wood 100 in different tracks. Therefore, the feeding machine of the present invention is convenient to use.

(3) Since the feeding wheels 31 can be disposed in a selected one of multiple positions, there is no need to purchase and store multiple conventional feeding machines at the same time, thereby reducing the molding cost and the storage cost.

(4) By virtue of the flexibility to adjust some components, the feeding machine of the present invention is suitable for multiple different kinds of bracket units 6.

While the present invention has been described in connection with what is considered the most practical embodiment, it is understood that this invention is not limited to the disclosed embodiment but is intended to cover various arrangements included within the spirit and scope of the broadest interpretation and equivalent arrangements.

What is claimed is:

1. A feeding machine, comprising:
a machine shell including a connecting portion that has a first connecting surface and a second connecting surface inclinedly connected to said first connecting surface;
a feeding unit connected to said machine shell and including a plurality of feeding wheels;
a driving unit connected to said machine shell and configured to drive said feeding wheels;
a rotating shaft unit including a shaft seat and a rotating shaft that is connected to said shaft seat, said shaft seat being threaded on a selected one of said first connecting surface and said second connecting surface; and
a bracket unit including a bracket seat that is pivotally connected to said shaft seat of said rotating shaft unit.

2. The feeding machine as claimed in claim 1, wherein said rotating shaft unit further includes an extending member that is connected to said shaft seat and that is threaded on said the other one of said first connecting surface and said second connecting surface.

3. The feeding machine as claimed in claim 2, wherein said connecting portion of said machine shell is formed with a plurality of threaded holes, and said rotating shaft unit further includes a plurality of said fixing holes that are formed in said shaft seat and said extending member, and that are aligned respectively with said threaded holes of said connecting portion of said machine shell, said feeding machine further comprising a plurality of lock bolts extending through said fixing holes and engaging respectively said threaded holes.

4. The feeding machine as claimed in claim 3, wherein number of said fixing holes of said rotating shaft unit is four, two of said fixing holes being adjacent to said rotating shaft and being formed in said shaft seat, the other two of said fixing holes being formed in said extending member.

5. The feeding machine as claimed in claim 3, wherein said connecting portion of said machine shell includes a plurality of ribs, each of said threaded holes extending through a corresponding one of said ribs.

6. The feeding machine as claimed in claim 1, wherein said rotating shaft of said rotating shaft unit is frustoconical, and said bracket seat of said bracket unit is formed with a frustoconical hole so as to permit said bracket seat to be sleeved rotatably on said rotating shaft.

7. The feeding machine as claimed in claim 6, wherein said bracket unit further includes a connecting rod that is mounted rotatably on said bracket seat and that has one end threadedly connected to said bracket seat, and a rotary lever extending laterally from the other end of said connecting rod, said rotary lever and said rotating shaft being respectively disposed at two opposite sides of said bracket seat.

8. The feeding machine as claimed in claim 7, wherein said shaft seat of said rotating shaft is further formed with two positioning holes, and said bracket unit further includes a positioning pin that is adjacent to said connecting rod, that extends through said bracket seat, and that extends into a selected one of said positioning holes of said shaft seat of said rotating shaft unit.

9. The feeding machine as claimed in claim 1, wherein said second connecting surface is inclined with respect to said first connecting surface at an angle of about 135 degrees.
